(19) United States
(12) Patent Application Publication
(10) Pub. No.: US 2009/0040234 A1
(43) Pub. Date: Feb. 12, 2009

(54) IMAGE PROCESSING DEVICE

(75) Inventors: Masao KOBAYASHI, Hachioji-shi (JP); Tadashi HAYASHI, Hino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/186,265

(22) Filed: Aug. 5, 2008

(30) Foreign Application Priority Data
Aug. 7, 2007 (JP) 2007-205040

(51) Int. Cl. G09G 5/02

(52) U.S. Cl. 345/604; 345/600

(57) ABSTRACT

An image processing device includes a first conversion unit including a color conversion matrix circuit that inputs first image data and outputs second image data. The color conversion matrix circuit is able to arbitrarily set a conversion coefficient.

The entire disclosure of Japanese Patent Application No. 2007-205040, filed Aug. 7, 2007 is expressly incorporated by reference herein.

### BACKGROUND

1. Technical Field

The present invention relates to an image processing device for allowing a color image outputting means to output a monochrome image based on input-color-image data or input-monochrome-image data.

The present invention also relates to an image processing device for allowing a monochrome image outputting means to output a monochrome image based on input-color-image data or input-monochrome-image data.

2. Related Art

Image processing devices, such as that disclosed in JP-A-6-59657, by which color image data is displayed on a monochrome binary display are known.

The image processing device (related art device) disclosed in JP-A-6-59657 is provided with a plurality of gray tables respectively corresponding to hues. In the device, a gray table corresponding to a hue of color data is selected from the plurality of gray tables and the gray table is referred so as to obtain a gray scale with respect to luminance. The gray scale is converted into a binary image by a dither pattern expressing contrasting density, whereby a halftone image of color image data can be clearly expressed.

Thus, related art devices can conduct a monochrome image output on a monochrome image outputting means by using color image data.

Here, a monochrome image is sometimes required to be outputted on a color image outputting device based on color image data or monochrome image data. In addition, a monochrome image is sometimes required to be outputted on a monochrome image output device based on color image data or monochrome image data.

### SUMMARY

An advantage of the present invention is to provide an image processing device that allows a color image outputting device to output a monochrome image based on color image data or monochrome image data and requires no special circuit for the output.

Another advantage of the present invention is to provide an image processing device that allows a monochrome image output device to output a monochrome image based on color image data or monochrome image data and requires no special circuit for the output.

In consideration of the above-mentioned cases, structures of the following aspects of the present invention are employed.

An image processing device, according to a first aspect of the present invention, that allows a color-image outputting means to output a monochrome image based on input-color-image data includes a first conversion unit that converts RGB data into YUV data such that the YUV data are composed of three pieces of Y data having same values as each other in a case where the input-color-image data is the RGB data. The color image outputting means uses the three pieces of Y data that are outputted from the first conversion unit as RGB data so as to output the input as a monochrome image.

The image processing device, according to the first aspect, that allows the color-image outputting means to output a monochrome image based on input-color-image data includes the first conversion unit that converts YUV data into YUV data such that the YUV data are composed of three pieces of Y data having same values as each other in a case where the input-color-image data is the YUV data. The color image outputting means uses the three pieces of Y data that are outputted from the first conversion unit as RGB data so as to output the input as a monochrome image.

The image processing device of the first aspect further includes a second conversion unit that converts each value of the three pieces of Y data outputted from the first conversion unit. The color image outputting means uses the three converted values as RGB data so as to output the input as a monochrome image.

The image processing device, according to the first aspect, that allows the color image outputting means to output a monochrome image based on input-monochrome-image data further includes a third conversion unit that extends density data of the input monochrome image as RGB data. A first conversion unit converts the RGB data that are obtained by the extension into three pieces of density data. The color image outputting means uses the three pieces of density data outputted from the first conversion unit as RGB data so as to output a monochrome image.

An image processing device, according to a second aspect of the invention, that allows a color image outputting means to output a monochrome image based on input color image or input monochrome image includes a first conversion unit. The first conversion unit has a first mode, a second mode, and a third mode and can set one of these modes in advance. In the first mode, in a case where the input-color-image data is RGB data, the RGB data is converted into YUV data so as to be outputted. The YUV data are composed of three pieces of Y data having same values as each other. In the second mode, in a case where the input-color-image data is YUV data, the YUV data is converted into YUV data so as to be outputted. The YUV data that is converted is composed of three pieces of Y data having same values as each other. In the third mode, in a case where the input-color-image data is density data of an input monochrome image, the density data is extended as RGB data and the RGB data obtained by the extension is converted into three pieces of density data so as to be outputted. The color image outputting means uses the three pieces of Y data or the three pieces of density data outputted from the first conversion unit correspondingly to the modes so as to output a monochrome image.

The image processing device of the second aspect further includes a second conversion unit that converts each value of Y data outputted from the first conversion unit into a predetermined value and converts each value of the three pieces of density data outputted from the first conversion unit into a predetermined value. The color image outputting means uses three converted values outputted from the second conversion unit as RGB data so as to output a monochrome image.

The image processing device, according to the second aspect, that allows a monochrome image outputting means to output a monochrome image based on input-color-image data includes the first conversion unit that extracts only Y data from YUV data in a case where input-color-image data is the YUV data. The monochrome image outputting means uses the Y data outputted from the first conversion unit as density data so as to output the input as a monochrome image.

The image processing device, according to the second aspect, that allows the monochrome image outputting means to output a monochrome image based on input-monochrome-image data further includes a third conversion unit that extends density data of the input monochrome image as RGB data. A first conversion unit converts the RGB data that are obtained by the extension into density data. The monochrome image outputting means uses the density data outputted from the first conversion unit so as to output a monochrome image.

An image processing device, according to a third aspect of the invention, that allows a monochrome image outputting means to output a monochrome image based on input-color-image data or input-monochrome-image data includes a first conversion unit. The first conversion unit has a first mode and a second mode and can set the first mode or the second mode in advance. In the first mode, Y data is extracted from YUV data to be outputted, in a case where the input-color-image data is the YUV data. In the second mode, density data is extended as RGB data and the RGB data obtained by the extension is converted into density data so as to output the density data, in a case where the input-color-image data is the density data of an input monochrome image. The monochrome image outputting means uses the Y data or the density data outputted from the first conversion unit correspondingly to the modes so as to output a monochrome image.

The image processing device of the third aspect further includes a second conversion unit that converts each value of the Y data or the density data outputted from the first conversion unit. The monochrome image outputting means uses converted values outputted from the second conversion unit so as to output a monochrome image.

According to the first and second aspects, the color image outputting device can be allowed to output a monochrome image based on color image data or monochrome image data, and thus a special circuit is not needed for the output.

Further, according to the third aspect, the monochrome image outputting device can be allowed to output a monochrome image based on color image data or monochrome image data, and thus a special circuit is not needed for the output.

### BRIEF DESCRIPTION OF THE DRAWINGS

The invention will be described with reference to the accompanying drawings, wherein like numbers reference like elements.

FIG. 1 is a block diagram illustrating a structure of a first embodiment of the present invention.

FIGS. 2A to 2C are diagrams illustrating a form of RGB data used in the first embodiment.

FIG. 3 is a flow chart showing a data processing for displaying a color image from RGB data.

FIG. 4 is a flow chart showing a data processing for displaying a monochrome image from RGB data.

FIG. 5 is a flow chart showing a data processing for displaying a color image from YUV data.

FIG. 6 is a flow chart showing a data processing for displaying a monochrome image from YUV data.

FIG. 7 is a flow chart showing a data processing for displaying a monochrome image from monochrome image data.

FIG. 8 is a block diagram illustrating a structure of an image processing system to which the first embodiment is applied.

FIG. 9 is a block diagram illustrating a structure of a second embodiment of the present invention.

FIG. 10 is a flow chart showing a data processing for displaying a monochrome image from RGB data.

FIG. 11 is a flow chart showing a data processing for displaying a monochrome image from YUV data.

FIG. 12 is a flow chart showing a data processing for displaying a monochrome image from monochrome image data.

FIG. 13 is a block diagram illustrating a structure of an image processing system to which the second embodiment is applied.

### DESCRIPTION OF EXEMPLARY EMBODIMENTS

Embodiments of the present invention will now be described with reference to the accompanying drawings.

### First Embodiment

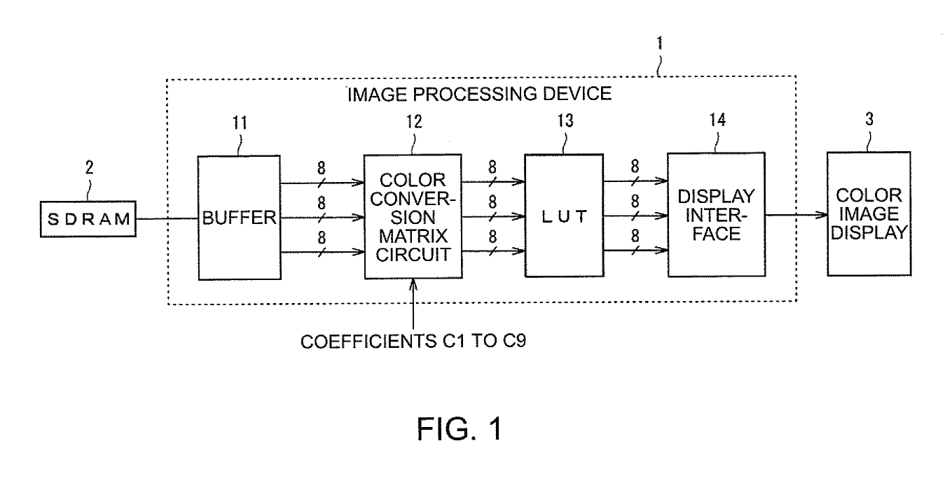

An image processing device 1 according to a first embodiment includes a buffer 11, a color conversion matrix circuit 12, a look up table (LUT) 13, and a display interface 14, as shown in FIG. 1.

The image processing device 1 allows a color image display 3 for displaying a color image to display a monochrome image as well as a color image based on color image data stored in a SDRAM 2 that is a memory. Further, the image processing device 1 allows the color image display 3 to display a monochrome image based on monochrome image data stored in the SDRAM 2.

The buffer 11 temporally stores color image data or monochrome image data that has been stored in the SDRAM 2.

The color conversion matrix circuit 12 performs a matrix operation as expressed in Formula 1 on three pieces of 8-bit data of an inputted color image so as to be converted into three pieces of predetermined 8-bit data and outputted.

$$( \begin{matrix}O 1 \\ O 2 \\ O 3\end{matrix} ) = ( \begin{matrix}C 1 & C 2 & C 3 \\ C 4 & C 5 & C 6 \\ C 7 & C 8 & C 9\end{matrix} ) ( \begin{matrix}I 1 \\ I 2 \\ I 3\end{matrix} ) \qquad Formula 1$$

Formula 1 is expanded to derive the following Formulas 2 to 4.

O1=(C1×I1)+(C2×I2)+(C3×I3) Formula 2

O2=(C4×I1)+(C5×I2)+(C6×I3) Formula 3

O3=(C7×I1)+(C8×I2)+(C9×I3) Formula 4

In Formulas 1 to 4, 11, I2, and I3 indicate input data, O1, O2, and O3 indicate output data, and C1 to C9 indicate coefficients.

The color conversion matrix circuit 12 can set an arbitrary value for each of the coefficients C1 to C9. If the coefficients C1 to C9 are set in advance of the data conversion, processing modes for various image data described later can be set.

The LUT 13 converts (changes) a value of each of the output data O1, O2, and O3 received from the color conversion matrix circuit 12 into a predetermined value. Therefore, the LUT 13 includes a memory, so that, in a case of the data O1 of 8 bits for example, if a desired value is written in the address in advance in a manner that the digital value corresponds to an address of the memory, the data conversion (amplitude processing operation) can be conducted by reading out contents of the memory. Here, the LUT 13 may be omitted.

The display interface 14 allows the color image display 3 to display a color image or a monochrome image based on three pieces of output data received from the LUT 13.

The color image display 3 is a liquid crystal display, for example. The color image display 3 can display a color image based on RGB data and display a monochrome image by using density data (luminance data) as RGB data. Further, the color image display 3 can display in a case of RGB data (each 6 bits) as well as a case of RGB data (each 8 bits) and can select those display modes.

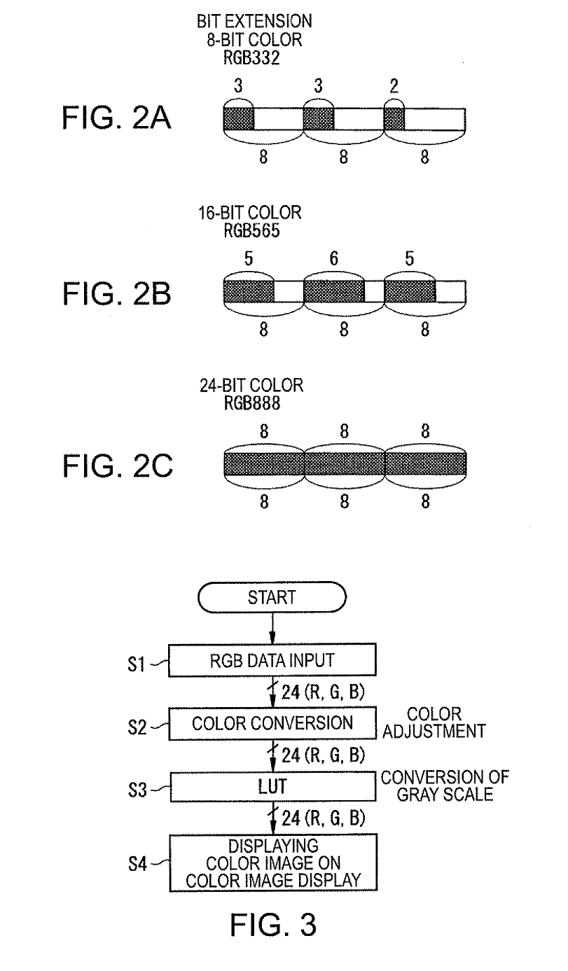

A form of image data processed in the above structure of the first embodiment will be described with reference to FIGS. 2A to 2C. FIGS. 2A to 2C show a form of RGB data of a color image.

FIG. 2A shows color image RGB data of 8 bits composed of R of 3 bits, G of 3 bits, and B of 2 bits (hereinafter, referred to as RGB332). The 3 bits, the 3 bits, and the 2 bits are respectively assigned in a part of R, G, and B data each having an 8-bit form as shown in FIG. 2A.

FIG. 2B shows color image RGB data of 16 bits composed of R of 5 bits, G of 6 bits, and B of 5 bits (hereinafter, referred to as RGB565). The 5 bits, the 6 bits, and the 5 bits are respectively assigned in a part of R, G, and B data each having an 8-bit form as shown in FIG. 2B.

FIG. 2C shows RGB color image data of 24 bits composed of R of 8 bits, G of 8 bits, and B of 8 bits (hereinafter, referred to as RGB888). The 8 bits, the 8 bits, and the 8 bits are assigned in the whole part of R, G, and B data each having an 8-bit form as shown in FIG. 2C.

A processing in a case of displaying a color image on the color image display 3 based on color image RGB data such as those shown in FIGS. 2A to 2C will be described with reference to FIGS. 1 and 3.

If RGB data are inputted into the color conversion matrix circuit 12 (step S1), the color conversion matrix circuit 12 converts the RGB data of 24 bits into RGB data of 24 bits (step S2). Thus, color adjustment is conducted.

Next, the LUT 13 converts (conducts grayscale conversion) respective data values of the RGB data that are converted in the color conversion matrix circuit 12 (step S3). Then a color image is displayed on the color image display 3 based on the RGB data that are converted (step S4).

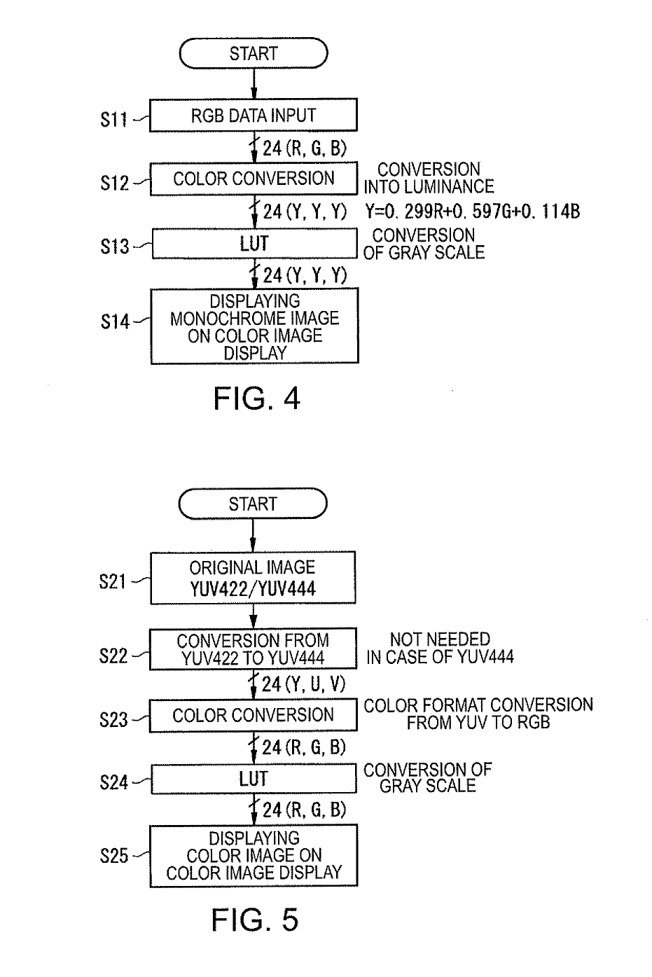

A processing in a case of displaying a monochrome image on the color image display 3 based on color image RGB data such as those shown in FIGS. 2A to 2C will be described with reference to FIGS. 1 and 4.

If RGB data are inputted into the color conversion matrix circuit 12 (step S11), the color conversion matrix circuit 12 converts the RGB data into YUV data. The conversion of the RGB data is conducted such that the YUV data are composed of three pieces of Y data (luminance data) having the same value as each other (step S12).

Such luminance conversion is conducted such that the RGB data are used as the input data I1 to I3, and the YUV data are used as the output data O1 to O3 in Formula 1. Further, the coefficients C1 to C9 are set in advance as the followings C1=C4=C7=0.299, C2=C5=C8=0.597, and C3=C6=C9=0.114. Accordingly, Formula 5 is derived from Formulas 2 to 4, and the three pieces of Y data (luminance data) having the same values as each other can be obtained as the YUV data.

Y=U=V=0.299R+0.597G+0.114B Formula 5

Next, the LUT 13 converts respective data values of the three pieces of Y data that are obtained by the conversion in the color conversion matrix circuit 12 (step S13). Then a color image is displayed as a monochrome image (achromatic image) on the color image display 3 by using the three pieces of Y data that are converted as RGB data (step S14).

A processing in a case of displaying a color image on the color image display 3 based on color image YUV data will be described with reference to FIGS. 1 and 5.

In this example, a case of processing YUV422 or YUV444 as original image YUV data (step 21) will be described. For example, in a case where the YUV422 are processed, the YUV422 are converted into the YUV444 (step S22). This conversion is conducted in a circuit which is not shown. In a case where the YUV444 are processed, the conversion is not needed.

If the YUV data that is converted into the YUV444 is inputted into the color conversion matrix circuit 12, the color conversion matrix circuit 12 conducts a color format conversion from the YUV data into RGB data (step S23).

Next the LUT 13 converts data values of the RGB data that are obtained by the conversion of the YUV data in the color conversion matrix circuit 12 (step S24). Then a color image is displayed on the color image display 3 based on the RGB data that are converted (step S25).

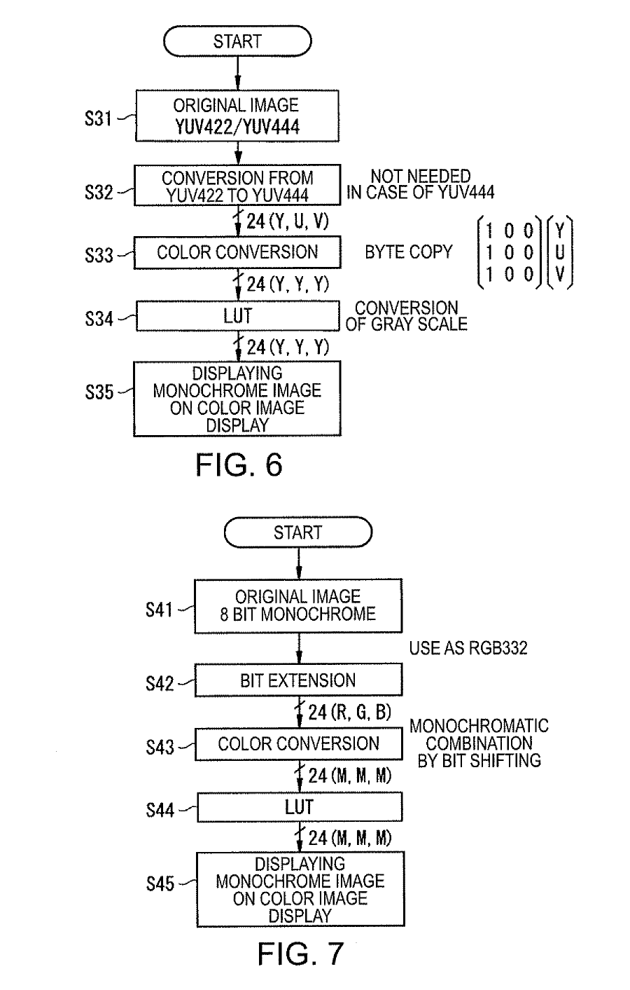

A processing in a case of displaying a color image as a monochrome image on the color image display 3 based on color image YUV data will be described with reference to FIGS. 1 and 6.

In this example, a case of processing YUV422 or YUV444 as original image YUV data (step 31) will be described. For example, in a case where the YUV422 are processed, the YUV422 are converted into the YUV444 (step S32). This conversion is conducted in a circuit which is not shown. In a case where the YUV444 are processed, the conversion is not needed.

If the YUV data that are converted into the YUV444 are inputted into the color conversion matrix circuit 12, the color conversion matrix circuit 12 converts the YUV data into YYY data that have the same values as each other (step S33).

Such conversion is conducted such that the YUV data are used as the input data I1 to I3, and the YUV data are used as the output data O1 to O3 in Formula 1. Further, the coefficients C1 to C9 are set in advance as the following: C1=C4=C7=1, C2=C5=C8=0, and C3=C6=C9=0. Accordingly, the three pieces of Y data (luminance data) can be obtained from the YUV data.

Next, the LUT 13 converts respective data values of the three pieces of Y data that are obtained by the conversion in the color conversion matrix circuit 12 (step 34). Then a color image is displayed as a monochrome image on the color image display 3 by using the three pieces of Y data that are converted as RGB data (step S35).

A processing in a case of displaying a monochrome image on the color image display 3 based on density data of a monochrome image will be described with reference to FIGS. 1 and 7.

A case of processing monochrome image density data of 8 bits, for example, as an original image (step S41) will be described. In this case, bits are extended so as to use the density data of 8 bits as the RGB332 data shown in FIG. 2A (step S42).

In this bit extending, the density data of 8 bits is divided into 3 bits, 3 bits, and 2 bits, and the 3 bits, the 3 bits, and the 2 bits are respectively assigned to R data, G data, and B data respectively having an 8-bit form (refer to FIG. 2A). Such bit extending is conducted in a circuit which is not shown, and the RGB data of which bits are extended is inputted into the color conversion matrix circuit 12.

The color conversion matrix circuit 12 converts the RGB data of which bits are extended into three pieces of density data M (step S43). This conversion can be conducted by bit-shifting the RGB data of which bits are extended.

Next, the LUT 13 converts respective data values of the three pieces of density data M that are obtained by the conversion in the color conversion matrix circuit 12 (step 44). Then a monochrome image is displayed on the color image display 3 by using the three pieces of density data M that are converted as the RGB data (step S45).

According to the first embodiment, the color image display 3 can be allowed to display a monochrome image based on color image data or monochrome image data, and thus a special circuit is not needed for the displaying, as described above.

Further, according to the first embodiment, a processing mode of the color conversion matrix circuit 12 can be set by software.

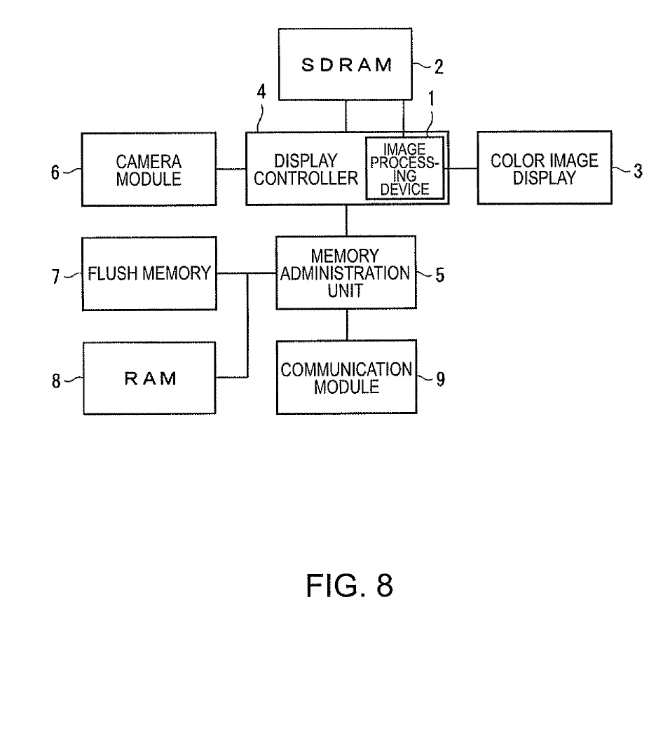

A structural example of an image processing system to which the image processing device 1 shown in FIG. 1 is applied will now be described with reference to FIG. 8.

This image processing system includes a display controller 4 controlling each unit and a memory management unit 5 conducting a memory management. In the display controller 4, the image processing device 1 that is coupled to the color image display 3 is provided. To the display controller 4, a camera module 6, the SDRAM 2, and the memory management unit 5 are coupled. To the memory management unit 5, a flush memory 7, a RAM 8, and a communicating module 9 are coupled.

A flow of image data in the image processing system having such structure will now be described with reference to FIG. 8.

(A) A case where color image data that is stored in the flush memory 7 in advance is read out by the memory management unit 5 so as to write it in the SDRAM 2 through the display controller 4. Examples of the color image data that is stored in the flush memory 7 in advance include RGB332, RGB565, RGB888, YUV422, and YUV444.

(B) A case where color image data or monochrome image data that is acquired by the communication module 9 is written in the RAM 8 by the memory management unit 5. Examples of the monochrome image data that is to be written in the RAM 8 include density data of 8 bits and examples of the color image data include RGB332, RGB565, RGB888, YUV422, and YUV444.

(C) A case where color image data or monochrome image data that is acquired by the communication module 9 and written in the RAM 8 is read out by the memory management unit 5 so as to write it in the SDRAM 2 through the display controller 4.

(D) A case where the image data that is stored in the SDRAM 2 is taken in the display controller 4.

(E) A case where image data outputted from the SDRAM 2 and the like is converted in the image processing device 1 so as to be displayed on the color image display 3.

The image data is not converted in the flow of the image data in the cases (A) to (D), while the data is converted by the image processing device 1 in a case where an image is displayed on the color image display 3 such as the case (E).

Therefore, according to the image processing system shown in FIG. 8, a monochrome image can be displayed on the color image display 3 based on RGB data or YUV data of a color image, or density data of a monochrome image.

### Second Embodiment

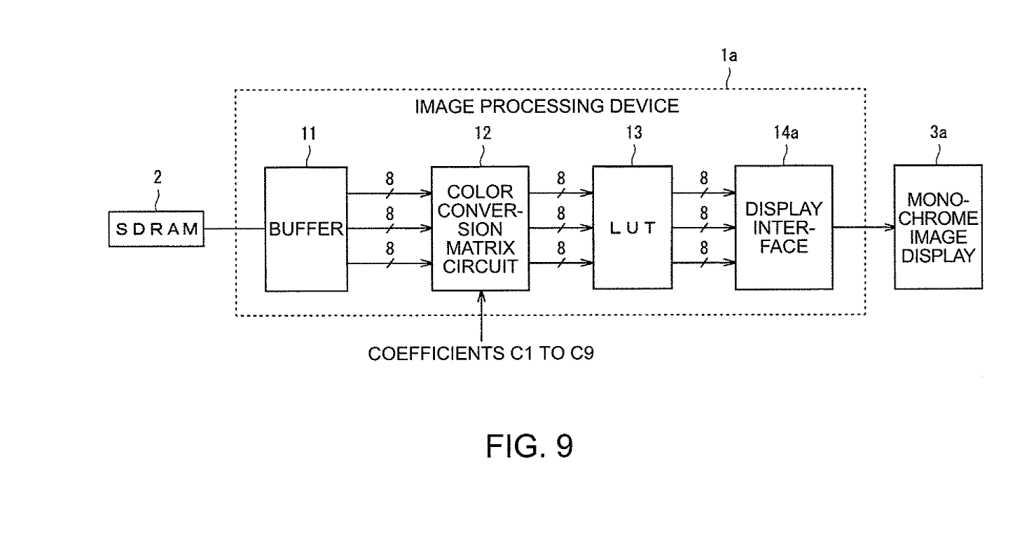

An image processing device 1a according to a second embodiment includes a buffer 11, a color conversion matrix circuit 12, a look up table (LUT) 13, and a display interface 14a as shown in FIG. 9.

Further, the image processing device 1a allows a monochrome image display 3a to display a monochrome image based on color image data or monochrome image data stored in a SDRAM 2 that is a memory.

A structure of this image processing device 1a is based on that of the image processing device 1 shown in FIG. 1. The device 1a has the display interface 14a instead of the display interface 14 shown in FIG. 1. Therefore, elements similar to those of the device 1 have the same reference numbers and descriptions thereof will be omitted as much as possible.

The display interface 14a allows the monochrome image display 3a to display a monochrome image based on three pieces of output data (density data) from the LUT 13.

The monochrome image display 3a is a liquid crystal display, for example. Further, the monochrome image display 3a can display a monochrome image based on the density data.

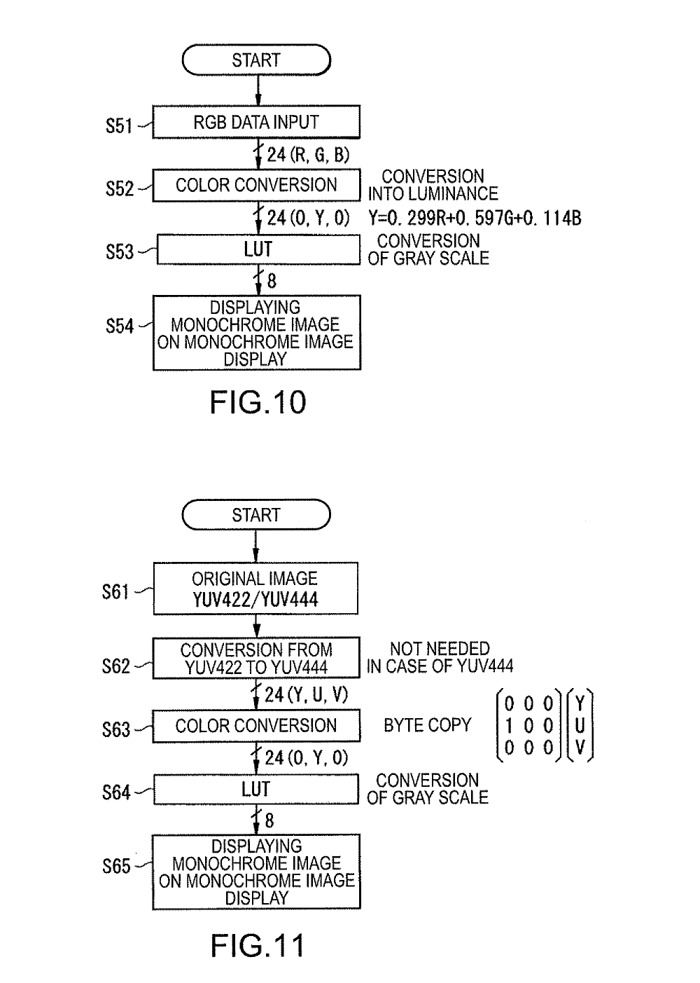

A processing in a case of displaying a monochrome image on the monochrome image display 3a based on color image RGB data such as those shown in FIGS. 2A to 2C will be described with reference to FIGS. 9 and 10.

If RGB data are inputted into the color conversion matrix circuit 12 (step S51), the color conversion matrix circuit 12 converts the RGB data into YUV data. The conversion of the RGB data is conducted such that only Y data (luminance data) are acquired (step S52).

Conversion formula in this case can be expressed as Formula 6 below.

Y=0.299R+0.597G+0.114B Formula 6

Next, the LUT 13 converts data values of the Y data that are obtained by the conversion in the color conversion matrix circuit 12 (step S53). Then a monochrome image is displayed on the monochrome image display 3a by using the Y data that are converted as the density data (step S54).

A processing in a case of displaying a monochrome image on the monochrome image display 3a based on YUV data of a color image will be described with reference to FIGS. 9 and 11.

In this example, a case of processing YUV422 or YUV444 as original image YUV data (step 61) will be described. For example, in a case where the YUV422 are processed, the YUV422 are converted into the YUV444 (step S62). This conversion is conducted in a circuit which is not shown. In a case where the YUV444 are processed, the conversion is not needed.

If the YUV data that are converted into the YUV444 are inputted into the color conversion matrix circuit 12, the color conversion matrix circuit 12 conducts a conversion such that only Y data can be obtained from the YUV data (step S63).

Such conversion is conducted such that the YUV data are used as the input data I1 to I3, and the YUV data are used as the output data O1 to O3 in Formula 1. Further, the coefficients C1 to C9 are set in advance as the following: C1 to C3=0, C4=1, and C5 to C9=0. Accordingly, U=Y is derived, being able to obtain only Y data (luminance data).

Next, the LUT 13 converts data values of the Y data that are obtained in the color conversion matrix circuit 12 (step S64). Then a monochrome image is displayed on the monochrome image display 3a by using the Y data that is converted (step S65).

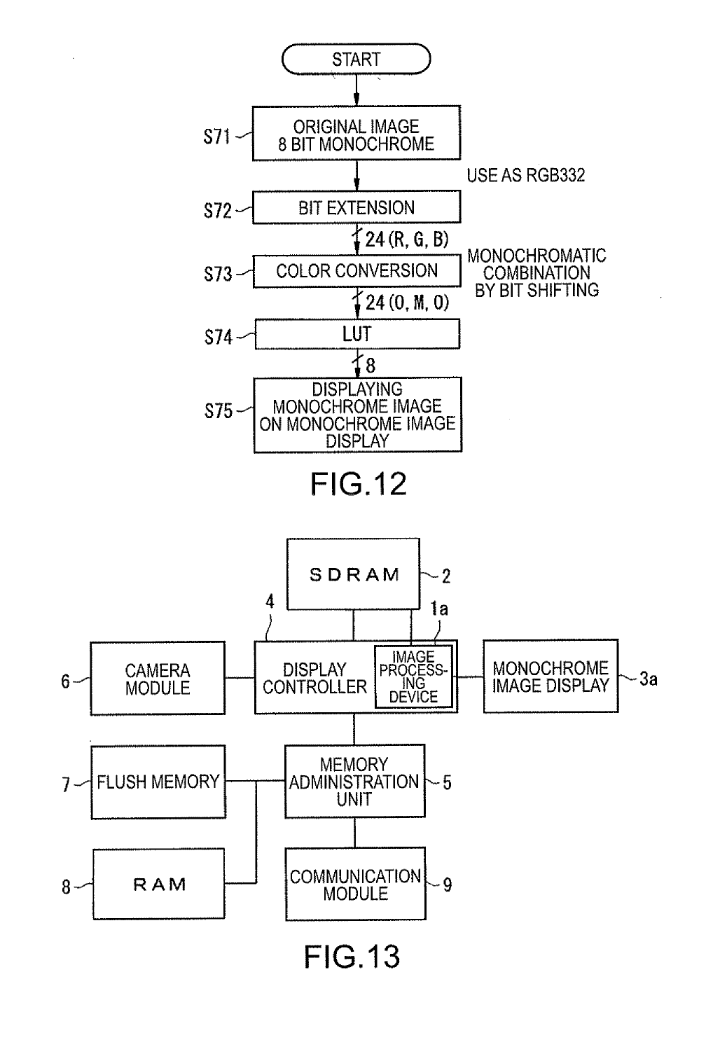

A processing in a case of displaying a monochrome image on the monochrome image display 3a based on density data of a monochrome image will be described with reference to FIGS. 9 and 12.

A case of processing monochrome image density data of 8 bits, for example, as an original image (step S71) will be described. In this case, bits are extended so as to use the density data of 8 bits as the RGB332 data shown in FIG. 2A (step S72).

In this bit extending, the density data of 8 bits is divided into 3 bits, 3 bits, and 2 bits, and the 3 bits, the 3 bits, and the 2 bits are respectively assigned to R data, G data, and B data respectively having an 8-bit form (refer to FIG. 2A). Such bit extending is conducted in a circuit which is not shown, and the RGB data is inputted into the color conversion matrix circuit 12.

The color conversion matrix circuit 12 converts the RGB data of which bits are extended into density data M (step S73). This conversion can be conducted by bit-shifting the RGB data of which bits are extended.

Next, the LUT 13 converts data values of the density data M that are obtained by the conversion in the color conversion matrix circuit 12 (step S74). Then a monochrome image is displayed on the monochrome image display 3a by using the density data M that are converted (step S75).

According to the second embodiment, the monochrome image display 3a is allowed to display a monochrome image based on color image data or monochrome image data and thus a special circuit is not needed for the displaying, as described above.

Further, according to the second embodiment, a processing mode of the color conversion matrix circuit 12 can be set by software.

A structural example of an image processing system to which the image processing device 1a shown in FIG. 9 is applied will now be described with reference to FIG. 13.

A structure of this image processing system is based on that of the image processing system shown in FIG. 8. This system includes an image processing device 1a and a monochrome image display 3a instead of the image processing device 1 and the color image display 3 of FIG. 8. Therefore, elements similar to those of the system of FIG. 8 have the same reference numbers and descriptions thereof will be omitted.

A flow of image data in the image processing system having such structure is same as that in the image processing system of FIG. 8, so that the description thereof will be omitted.

According to the image processing system shown in FIG. 13, a monochrome image can be displayed on the monochrome image display 3a based on YUV data of a color image or density data of a monochrome image by using a color converting function of the image processing device 1a.

What is claimed is:

1. An image processing device, comprising:
a first conversion unit including a color conversion matrix circuit that inputs first image data and outputs second image data,
the color conversion matrix circuit being able to arbitrarily set a conversion coefficient.

2. The image processing device according to claim 1,
in a case where the first image data is a color image of RGB data, the first conversion unit outputting RGB data obtained by color-converting the first image data as the second image data, and
the second image data being used as RGB data so as to output a color image.

3. The image processing device according to claim 1,
in a case where the first image data is a color image of RGB data, the first conversion unit outputting YUV data obtained by converting the first image data as the second image data,
the second image data including three pieces of Y data having same values as each other, and
the second image data being used as RGB data so as to output a monochrome image.

4. The image processing device according to claim 1,
in a case where the first image data is a color image of YUV data, the first conversion unit outputting YUV data obtained by converting the first image data as the second image data,
the second image data including three pieces of Y data having same values as each other, and
the second image data being used as RGB data so as to output a monochrome image.

5. The image processing device according to claim 1, further comprising:
a second conversion unit converting each value of the second image data into a predetermined value so as to output the converted data as third image data,
the third image data being used as RGB data so as to output a monochrome image.

6. The image processing device according to claim 1, further comprising:
a third conversion unit outputting fourth image data obtained by extending density data of the first image data as RGB data, in a case where the first image data is a monochrome image,
the first conversion unit converting the fourth image data so as to output the data as the second image data, and
the second image data being used as RGB data so as to output a monochrome image.

7. An image processing device, comprising:
a first conversion unit including a color conversion matrix circuit that inputs first image data and outputs second image data,
the first conversion unit having:
a first mode in which in a case where the first image data is RGB data, the RGB data is converted into YUV data so as to be outputted, the YUV data being composed of three pieces of Y data having same values as each other;
a second mode in which in a case where the first image data is YUV data, the YUV data is converted into YUV data so as to be outputted, the YUV data being composed of three pieces of Y data having same values as each other; and
a third mode in which in a case where the first image data is density data of a monochrome image, the density data is extended as RGB data, and the RGB data is converted into three pieces of density data so as to be outputted, and
the second image data outputted from the first conversion unit being used as RGB data correspondingly to the first, second, and third modes so as to output a monochrome image.

8. The image processing device according to claim 7, further comprising:
a second conversion unit converting each value of the second image data into a predetermined value so as to output the data as third image data, and
the third image data being outputted as RGB data so as to output a monochrome image.

9. The image processing device according to claim 7,
in a case where the first image data is YUV data, the first conversion unit extracting only Y data from the first image data so as to output the Y data as the second image data, and
the second image data being used as density data so as to output a monochrome image.

10. The image processing device according to claim 7, further comprising:
a third conversion unit outputting fourth image data obtained by extending density data of the first image data as RGB data, in a case where the first image data is a monochrome image,
the first conversion unit converting the fourth image data so as to output the data as the second image data, and
the second image data being used as density data so as to output a monochrome image.

11. An image processing device, comprising:
a first conversion unit including a color conversion matrix circuit that inputs first image data and outputs second image data,
the first conversion unit having: a first mode in which in a case where the first image data is YUV data, Y data is extracted from the YUV data to be outputted; and
a second mode in which in a case where the first image data is density data of a monochrome image,
the density data is extended as RGB data, and the RGB data is converted into density data so as to be outputted,
the second image data outputted from the first conversion unit being used as density data correspondingly to the first and second modes so as to output a monochrome image.

12. The image processing device according to claim 11, further comprising:
a second conversion unit conversing each value of the second image data into a predetermined value so as to output the converted data as third image data,
the third image data being used as density data so as to output a monochrome image.
